(19) United States
(12) Patent Application Publication
(10) Pub. No.: US 2018/0164562 A1
(43) Pub. Date: Jun. 14, 2018

(54) CONFOCAL MICROSCOPY SYSTEM WITH VARI-FOCUS OPTICAL ELEMENT

(71) Applicants: JINA BYEON, Daejeon (KR); KI BOK KIM, Gueonggi-do (KR); SEUNGPYO HONG, Seoul (KR); GYOUNG IL CHO, Fullerton, CA (US); JIN YOUNG SOHN, Fullerton, CA (US); CHEONG SOO SEO, Brea, CA (US)

(72) Inventors: JINA BYEON, Daejeon (KR); KI BOK KIM, Gueonggi-do (KR); SEUNGPYO HONG, Seoul (KR); GYOUNG IL CHO, Fullerton, CA (US); JIN YOUNG SOHN, Fullerton, CA (US); CHEONG SOO SEO, Brea, CA (US)

(73) Assignees: Stereo Display, Inc., Anaheim, CA (US); SD Optics, Inc., Seoul (KR)

(21) Appl. No.: 15/333,188

(22) Filed: Oct. 25, 2016

(51) Int. Cl. G02B 21/00; G02B 21/02; G02B 21/06

(52) U.S. Cl. CPC G02B 21/006; G02B 21/025; G02B 21/06; G02B 21/0048; G02B 21/008

(57) ABSTRACT

The present invention utilizes aperture array element and vari-focus optical element in confocal microscopy system. With the aperture array element lateral scanning property can be obtained and with vari-focus optical element axial scanning property can be obtained. Especially Micromirror Array Lens is used as a vari-focus optical element, fast and extended depth of focus scan range can be obtained. Thus the present invention of confocal microscopy with the vari-focus optical element increases scan speed of confocal microscopy system. The confocal microscopy system of the present invention comprises an illumination source, an aperture array element, a vari-focus optical element, an objective lens element, a photosensitive optical sensor device. With these elements, confocal microscopy is performed to get three dimensional images. Three dimensional with the confocal microscopy of the present invention can be obtained three dimensional images: two dimensional lateral images can be obtained with aperture array element scanning laterally with multiple aperture to increase scanning speed and the depth information of each pixel in two dimensional image can be determined by the vari-focus optical element. Thus three dimensional images can be reconstructed by the two dimensional imaged obtained from lateral scan and depth information from the axial scan. The present invention of the confocal microscopy system improves slow speed of the confocal system with considerable amount by use of fast varying vari-focus optical element and fast scanning aperture array element.

### BACKGROUND OF THE INVENTION

The present invention relates to general optical microscopy and more specifically optical confocal microscopy systems.

Invention of confocal microscopy can be traced back to year, 1957 (U.S. Pat. No. 3,013,467). It was invented for having resolution power to height information and for extending depth of focus in the optical microscopy system. Confocal means that illumination light source, objective focal point and focus on the sensors are in focus together at the same time.

In confocal system, the light in confocal microscopy system, only a focused point of object plane is detected through an aperture while illumination light passes through the aperture. The aperture of the illumination system and focus objective plane share focus and correspond to conjugate points each other. The light in the confocal microscopy then makes an image of object only through an aperture with focused point, thus the resolution of the microscopy system can be enhanced through this confocal property.

Basically, confocal microscope system is using point light source. Thus to get a two dimensional image, confocal microscopy system requires a lateral scanning system for obtaining information with lateral direction parameters. Also to get a three dimensional image, confocal microscopy system requires an optically depth wise scanning apparatus for obtaining depth information as well as lateral scanning system for two dimensional image.

When restricted in two dimensional imaging confocal systems, there are two kinds of scanning methods. One is point scanning and the other is line scanning methods. Point scanning method was firstly proposed in 1969 by M. David Egger and Paul Davidovits from Yale University. This idea was published in Nature 223, 831 (23 Aug. 1969).

In point scanning method, laser beam (or illumination light) is projected onto one of the object plane points and this point sourced light was imaged through the aperture of the confocal system onto photo-sensor. This point scanning method can improve sensitivity or resolution, but it has a critical problem of very slow speed for getting images

In FIG. 1, brief schematic diagram of point scanning confocal system is given. Light beam from illumination source 11 was first filtered through an aperture 12. A beam splitter 13 is used for easy light path from the illumination source 11 to detector 17. Then the light beam passed through the aperture 12 is scanned to cover all the region of interest by scanning mirror 14. Alternatively, optical beam scanner is used for scanning object plane of the system. An objective lens 15 is used for making image onto the detector 17. The light beam passed through scanning mirror 14 passes through objective lens 15 and is reflected from the surface of object sample 16. Then finally the reflected light beam makes an image onto detector 17 through the optical aperture 12.

To obtain enhanced two dimensional image resolution, the size of the aperture 12 plays an important role in the confocal microscopy system. Also the speed and resolution of the scanning mirror 14 determines the image capturing speed of the system and the speed of the microscopy system. To extend the two dimensional image into three dimensional image, another scan axis is necessary. Axial scanning device should be used to get depth wise information of the object sample 16 as well as lateral scanning of the objective plane by another dimension scanning device.

To improve the speed of the confocal microscopy system, line scanning method was proposed. In the line scanning confocal microscopy system, illumination light (usually laser beam for high intensity) is projected with line shape. The projected line beam is scanned with special apparatus such as galvanometer mirror to get whole two dimensional image. In the line scanning method, one scanning axis is required for two dimensional image taking since the other dimension of the image scanning is obtained through line beam of the system. But in return of speed, the line scanning method has less sensitivity and less resolution compared with point scanning method.

FIG. 2 shows schematic diagram of the line scanning confocal microscopy system. Since this system uses the line beam instead of the point beam. This system does not need to scan in two dimensional directions at the same time. Thus in the line scanning confocal microscopy system, the speed of getting a two dimensional image is much faster than that of the point scanning confocal microscopy system. To have a line beam, the line scanning confocal microscopy system uses line aperture 22. Light beam from illumination source 21 passes through the line aperture 22. Then the illumination source becomes line shape corresponding to the shape of the line aperture 22. Other elements in the line scanning system are similar with those of point scanning microscopy system. Line beam is reflected by the beam splitter 23 and scanned by the scanning mirror 24. Usually galvanometer mirror is most widely used for this scanning mirror 24. This scanner mirror scans only in one dimensional direction instead of two dimensional planar scanning. Since the line beam is used, only one dimensional scanning makes two dimensional plane. The objective lens 25 focuses line beam for imaging onto the object sample 26. Reflected line beam this time passes through the beam splitter and finally makes an image onto the detector 27.

Similar with point scanning confocal microscopy system, line scanning confocal microscopy system requires another dimensional scanning device for depth wise scanning. This depth wise scanning device scans through the axial direction of the optical system and thus makes depth information of the object sample 26. Line scanning gives faster imaging speed than point scanning confocal microscopy system. Still it has speed problem for three dimensional scanning of the object sample.

Nipkow disk scanning method was firstly proposed in the year of 1883 by Paul Gottlieb Nipkow. This idea was published in patent office in Berlin for a patent covering an electric telescope for the electric reproduction of illuminating objects, in the category “electric apparatuses”. This was granted on 15 Jan. 1885, retroactive to Jan. 6, 1884. Programmable array microscope (PAM) was another example of the fast scanning confocal microscopy system. Nipkow disk system was commercialized but it suffered low efficiency of light usage in the system.

FIG. 3 shows diagram of Nipkow disk scanning system. The light beam 31 from the illumination source passes through a rotating Nipkow disk 32. Nipkow disk has many concentrically distributed aperture holes 33. These holes are distributed like multiple spiral shape. Only by rotating of the Nipkow disk 32 the system can cover the optical region of interest. While Nipkow disk is rotating, the light beam passed through the Nipkow disk 32 and makes a suitable illumination source for confocal microscopy system. Also since Nipkow disk is only rotating about an axis, configuration of the system becomes much simpler. The beam from the Nipkow disk now passes through the beam splitter 34 and the objective lens 35 and hit the object sample 36. The reflected light beam from the object sample not back through the objective lens 35 to make an image on to the detector 37. This time beam splitter 34 reflects the light beam to the detector 37. To get a three-dimensional image, it also needs another dimension scanning device for the system. Nipkow disk system has many advantages but it suffers efficiency of the light for the imaging system.

Another method was invented with programmable array device. Programmable array microscopes (PAM) use an electronically controlled spatial light modulator (SLM) that produces a set of moving apertures. The SLM is a device containing an array of pixels with some property (opacity, reflectivity or optical rotation) of the individual pixels that can be adjusted electronically. The SLM contains microelectromechanical mirrors or liquid crystal or some other apparatus components. The image is usually acquired by a charge coupled device (CCD) camera. In practice, Nipkow and PAM allow multiple apertures scanning the same area in parallel as long as the apertures are sufficiently far apart (described in U.S. Pat. No. 5,597,832, U.S. Pat. No. 5,923,466, U.S. Pat. No. 7,339,148 B2).

In FIG. 4, how Spatial Light Modulator makes array of apertures was illustrated. Based on device types, SLM can be categorized into two groups. One is transmission type SLM and the other is reflection type SLM. In the left figure of FIG. 4, transmission type SLM method is illustrated. Incident light 41 passes through transmission type SLM 42. SLM makes incident light 41 pass only when the pixel in the SLM 42 is on. Those passed light 43 can be used in the confocal microscope. In the right figure of FIG. 4, reflection type SLM method is illustrated. Incident light 44 reflected by the reflection type SLM 45. SLM makes the incident light 44 reflect only when the pixel in the SLM 45 is on. Those reflected light 46 can be used in the confocal microscope. After modulating incident light, the modulated light is used for making images for confocal system. Usually SLM is controlled by electronically and has a very fast speed. Liquid Crystal Display (LCD) device is a good example of transmission type SLM and Digital Micromirror Device (DMD) is a good example of reflection type SLM. These aperture array by spatial light modulator can make multiple optical apertures for confocal microscopy system. As long as the aperture is far enough not to interfere each other in image plane, as many as multiple apertures can be used at the same time to increase scanning speed of the confocal microscopy system. Still even with this method, there should be another dimensional scanning device for getting three dimensional information of the object by the confocal microscopy system. Fast and reliable axial scanning device is required to solve the speed of the confocal microscopy system.

Also confocal microscopy system has an advantage of superior depth wise resolution. It can obtain a three dimensional image through depth wise scanning methods with better resolution and the resolution of conventional microscopes, since it images only through focused light through an aperture with confocal property. But physically to get a good depth resolution, it requires a fine resolution scanning stage. Mostly piezo electrical transducer (PZT) was used to get a depth wise scanning property. When it comes to PZT, it can provide a good resolution but has a critical problem of short scanning range. Other scanning methods such as stepping motor stage, has a good scanning range but they do not have a good resolution of depth. Getting enough long range of scanning depth and enough speed of scanning has been an important issue for confocal microscopy system.

### SUMMARY OF THE INVENTION

The present invention contrives to enhance speed and reliability of three-dimensional scanning confocal microscopy system by use of an aperture array and a Micromirror Array Lens.

Main purpose of the present invention is to improve three dimensional scanning speed of the confocal microscopy system by use of the aperture array and the Micromirror Array Lens. Also in the present invention, since no macro-motion scanning device is used, reliable three dimensional scanning system could be achieved. Not using macro-motion gives great advantages against prior art of the confocal microscopy systems. It can avoid vibration effects while maintaining images in focus (usually takes some time due to scanning of the individual axes). Also, present invention provides a good resolution of the depth-scanning parameter.

In the present invention, an illumination light beam passes through the aperture array. The element, which corresponds to the aperture array, is controlled mechanically or electrically and makes the illumination light beam for satisfying confocal conjugate condition of the system. Especially when the aperture array is controlled through electrical method, it can generate high speed for lateral scanning for the two dimensional imaging in the confocal microscopy system.

In the present invention, a vari-focus optical element is introduced as a three-dimensional scanning device, especially depth wise scanning is obtaining through the vari-focus optical element. By changing focal plane of the confocal microscopy system, confocal points of the object can be scanned through changing of the focal plane of the vari-focus optical element. The scanning range of the vari-focus optical element can be a depth-scanning range of the confocal microscopy system. In confocal microscopy system, image is taken through confocal points of object and the illumination source and image plane. Since the object plane of the confocal system is scanned by the vari-focus optical element though changing optical focusing plane of the optical system.

If the Micromirror Array Lens is used as a vari-focus optical element, it can generate high speed of depth scanning. The Micromirror Array Lens can generate reliable and repeatable focal scanning as well as high enough speed for the imaging speed. With the Micromirror Array Lens the main problem, speed of the confocal microscopy system can be enhanced based on focus varying speed of the Micromirror Array Lens. The general principle and methods for making the Micromirror Array Lens are disclosed in U.S. Pat. No. 6,934,072 issued Aug. 23, 2005 to Kim, U.S. Pat. No. 6,934,073 issued Aug. 23, 2005 to Kim, U.S. Pat. No. 6,970,284 issued Nov. 29, 2005 to Kim, U.S. Pat. No. 6,999,226 issued Feb. 14, 2006 to Kim, U.S. Pat. No. 7,031,046 issued Apr. 18, 2006 to Kim, U.S. Pat. No. 7,095,548 issued Aug. 22, 2006 to Cho, U.S. Pat. No. 7,161,729 issued Jan. 9, 2007 to Kim, U.S. Pat. No. 7,239,438 issued Jul. 3, 2007 to Cho, U.S. Pat. No. 7,267,447 issued Sep. 11, 2007 to Kim, U.S. Pat. No. 7,274,517 issued Sep. 25, 2007 to Cho, U.S. Pat. No. 7,489,434 issued Feb. 10, 2009 to Cho, U.S. Pat. No. 7,619,807 issued Nov. 17, 2009 to Baek, and U.S. Pat. No. 7,777,959 issued Aug. 17, 2010 to Sohn, all of which are incorporated herein by references. And the detail of the general properties of the Micromirror Array Lens are disclosed in U.S. Pat. No. 7,173,653 issued Feb. 6, 2007 to Gim, U.S. Pat. No. 7,215,882 issued May 8, 2007 to Cho, U.S. Pat. No. 7,236,289 issued Jun. 26, 2007 to Baek, U.S. Pat. No. 7,354,167 issued Apr. 8, 2008 to Cho, U.S. patent application Ser. No. 11/218,814 filed Sep. 2, 2005, and U.S. patent application Ser. No. 11/382,273 filed May 9, 2006, all of which are incorporated herein by references.

And the Micromirror Array Lens can generate more than order of magnitude longer length of the focal plane shift that that by piezo electric transducer. Thus, the present invention with the Micromirror Array Lens can overcome short scanning range of the piezo-electric transducer driven confocal microscopy system as well as low speed scanning limit of the confocal scanning microscopy system.

The present invention comprises of an illumination source, an array aperture wherein the aperture controls conjugate of the confocal system for lateral scanning, wherein the vari-focus optical element performs depth wise scanning through changing focal plane of the confocal microscopy system, an objective lens element, and a photo-sensitive optical sensor device.

The present invention provides a high speed three dimensional scanning method. Since no macro-moving structure is used, vibration effect can be eliminated and thus good image quality with reliability can be obtained. Thanks to high scanning speed of the system, the present invention can be used in many industrial fields where three dimensional object images are essential.

Although the present invention is briefly summarized, the full understanding of the invention can be obtained by the following drawings, detailed descriptions, and appended claims.

### DESCRIPTION OF FIGURES

These and other features, aspects and advantages of the present invention will become better understood with reference to the accompanying drawings, wherein

FIG. 1 illustrates point scanning confocal microscopy system (prior art);

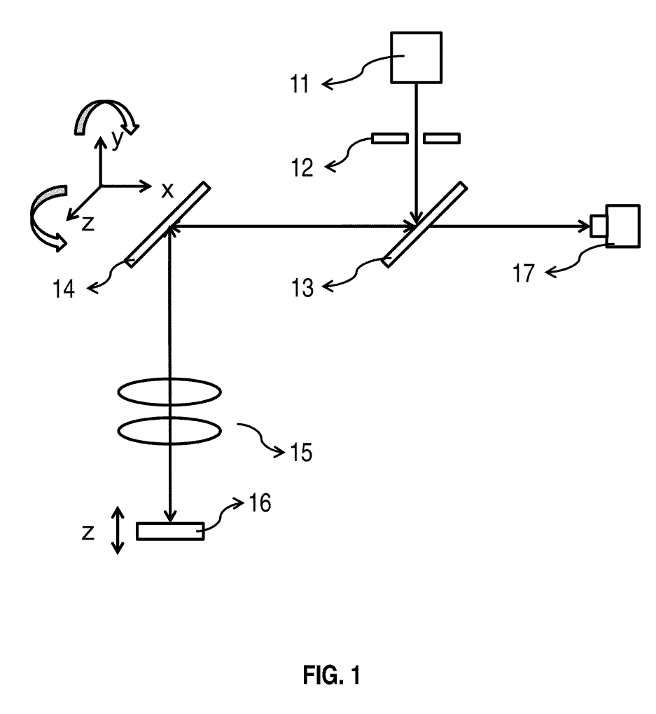

FIG. 2 illustrates line scanning confocal microscopy system (prior art);

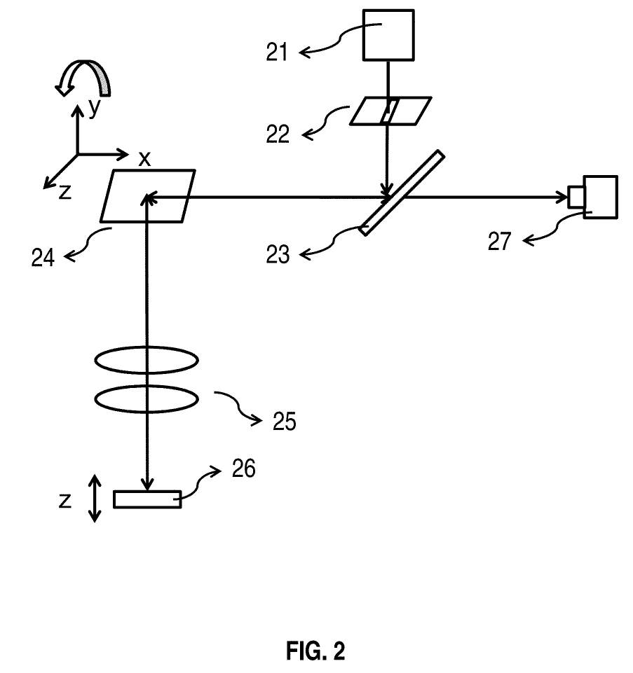

FIG. 3 illustrates scanning confocal microscopy system with rotating Nipkow disk (prior art);

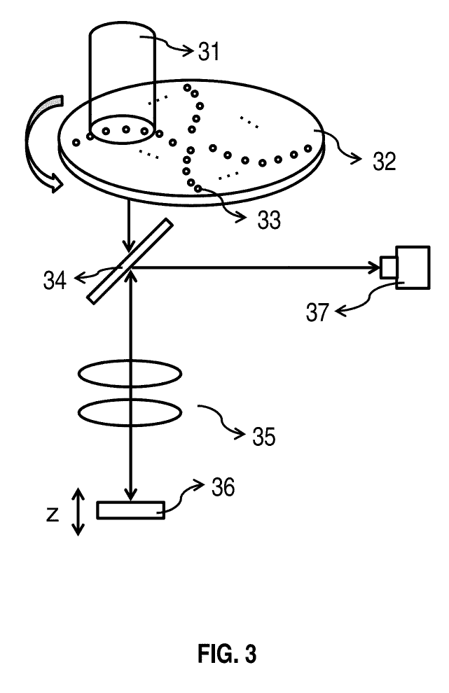

FIG. 4 shows transmission type and reflection type spatial light modulator used in confocal microscopy system (prior art)

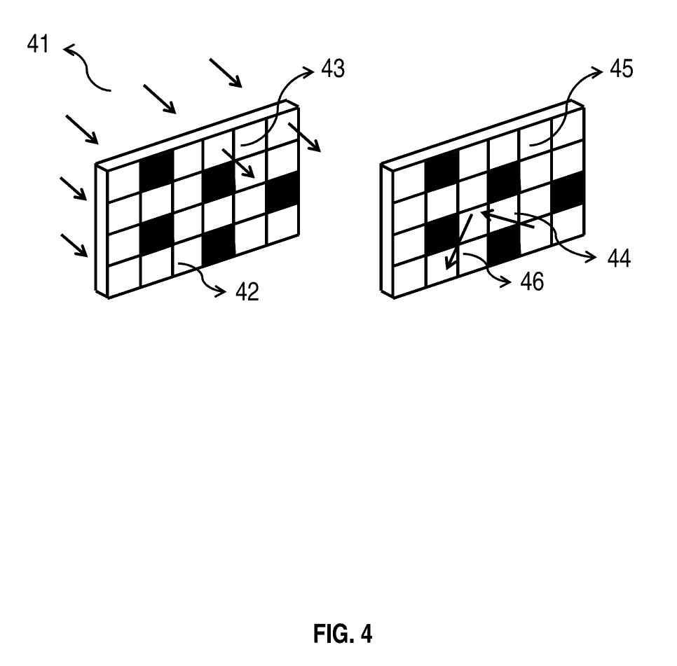

FIG. 5 shows first configuration of the present invention with Micromirror Array Lens (axis symmetric Micromirror Array Lens is used);

FIG. 6 shows second configuration of the present invention with Micromirror Array Lens (non-axis symmetric Micromirror Array Lens is used);

FIG. 7 shows third configuration of the present invention with multiple color configuration;

FIG. 8 shows fourth configuration of the present invention with liquid optical element configuration;

FIG. 9 shows three-dimensional design of the present invention, confocal microscopy system with the vari-focus optical element;

FIG. 10 shows scanning images of the confocal microscopy image using spatial light modulator method;

FIG. 11 shows image taken by the present invention reconstructed by use of multiple aperture scanning by the spatial light modulator;

FIG. 12 shows an example of three dimensional image taken by the present invention of confocal microscopy system with vari-focus optical element.

### DETAILED DESCRIPTION OF THE ILLUSTRATED EMBODIMENTS

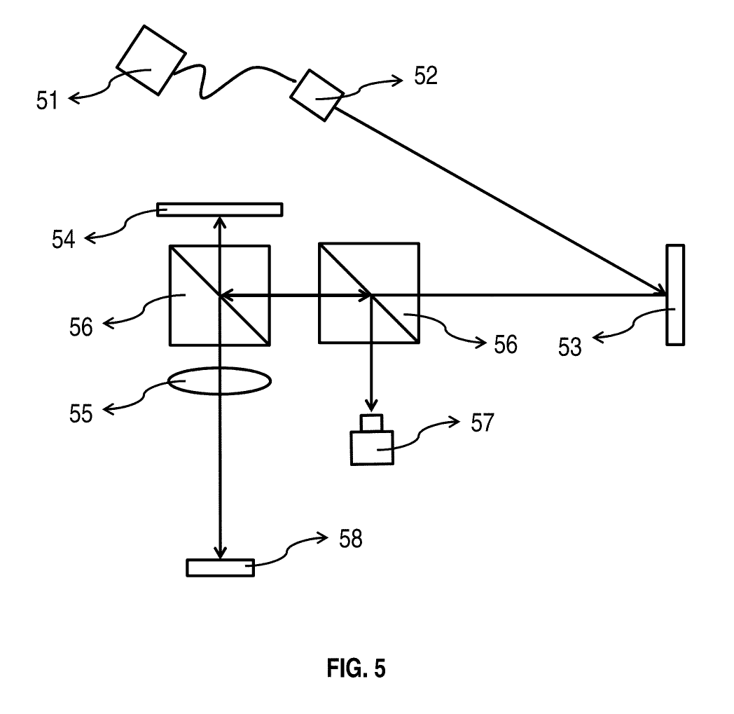

The present invention comprises of an illumination source, an aperture array element, and a vari-focus optical element, an objective lens and a photosensitive optical sensor device. FIG. 5 shows one example of the present invention. Light beam was launched from the illumination source 51 and the light beam is optionally collimated by the collimating element 52. The collimating element produces suitable optical beam size, divergence for the confocal microscopy system. In this example, DMD (digital micromirror device) is used as an aperture array element 53. In this specific example, the aperture array element is generated by turning on/off each pixel in SLM (spatial light modulator). DMD device is a good example of SLM.

Reflected light beam from the aperture array element 53 is now multiple illumination sources for corresponding apertures in the confocal microscopy image. Beam splitters 56 are used for redirecting the light beam without breaking the axis symmetry of the confocal microscopy system. The light beam is firstly reflected by the vari-focus optical element 54. In this figure, the vari-focus element is using reflective geometry rather than transmission one. Then reflected light beam in which the focal plane of the confocal image was changed by the vari-focus element 54 passes through the objective lens 55. The objective lens 55 makes an image from the object sample 58 onto the photosensitive optical sensor device 57.

While the aperture array element 53 is making aperture arrayed beam, there should be enough separation for avoiding confocal image interference between confocal points. These apertures in the aperture array element 53 moves with time to scan object sample 58 laterally. The apertures are moving together to cover all the field of view of the object sample 58. When the lateral scanning done a two dimensional image can be obtained. This image should be obtained through software algorithm with filtering clear image pixels from the taken confocal images. Each pixel is selected from the group of the images taken by the confocal microscopy system. In other words, the image pixels from the sensor with sharing confocal property can only be selected for confocal microscopy images. Thus image quality of the confocal microscopy system can be enhanced beyond the diffraction limit of the optical system.

To increase speed of taking images, usually SLM (aperture array element) is usually controlled by electronic signal. Digital Micromirror Device or Liquid Crystal Display device are good examples for the SLM. With this fast controlling SLM, lateral scanning of the image can be obtained. To get three dimensional images, another axis of scanning is required. For this axial scanning, the vari-focus optical element is used. With changing vari-focal property of the vari-focus optical element, focal plane of the objective lens can be scanned. This focal plane change can be used as an axial scanning. Thus, the vari-focus optical element is used as an axial scanning device.

In the present invention, a confocal system with vari-focus optical element is proposed comprising an illumination source, an aperture array element, a vari-focus optical element wherein the vari-focus optical element changes focal plane of the system, an objective lens element, and a photosensitive optical sensor device wherein said focal plane changing optical element changes focal plane of the system to obtain depth information. Micromirror Array Lens has a very fast response time and repeatability thus it can be used for fast depth wise scanning device. With the Micromirror Array Lens and the aperture array element with spatial light modulator, three dimensional scanning can be obtained. Micromirror Array Lens for depth wise scanning and the aperture array with spatial light modulator for lateral scanning.

A Micromirror Array Lens can be used as the vari-focus optical element in the confocal system. The Micromirror Array Lens comprises of multiple micromirrors wherein the micromirrors reflects light so that the micromirrors make lens surface as a vari-focus optical element. The micromirrors in the Micromirror Array Lens have individual rotation and translation satisfying convergence condition of the system. The Micromirror Array Lens changes focal plane of the system with each micromirror angle in the Micromirror Array Lens while satisfying phase matching condition.

There are two conditions to make a perfect lens. The first is the converging condition that all light rays scattered by one point of an object should converge into one point of an image plane. The second is the same phase condition that all converging light rays should have the same phase at the image plane. The surface shape of conventional reflective lens is formed to satisfy these perfect lens conditions by having all light rays scattered by one point of an object converged into one point of the image plane and the optical path length of all converging light rays to be the same

The present invention of confocal system with vari-focus optical element comprises an illumination source, an aperture array element, a vari-focus optical element wherein the vari-focus optical element changes focal plane of the system, an objective lens element, and a photosensitive optical sensor device, wherein said focal plane changing optical element changes focal plane of the system to obtain depth information.

The vari-focus optical element in the present invention can be a Micromirror Array Lens. The Micromirror Array Lens comprises of multiple micromirrors wherein the Micromirror Array Lens reflects light so that the micromirrors makes lens surface. The micromirrors in the Micromirror Array Lens have individual rotation and translation satisfying convergence condition of the system. The Micromirror Array Lens changes focal plane of the system with each micromirror angles in the Micromirror Array Lens while satisfying phase matching condition.

The illumination source in the confocal system with vari-focus optical element is collimated by an optical lens or lenses. The illumination source is collimated by an optical lens or lenses.

The aperture array element in the confocal system with vari-focus optical element comprises a pixel switching element. The pixel switching element makes optical aperture or optical apertures wherein the optical aperture is built by electric property of the pixel switching element with individual pixel controlling. The pixel switching element further comprises an actuator wherein the actuator makes the mask pattern moving for changing focal plane of the system.

The array aperture element in the confocal system with vari-focus optical element comprises a Nipkow disk wherein the Nipkow disk comprises pattern of circular path traced and the pattern comprises small pinhole, wherein the beam passing through the pinhole illuminates the object samples while rotating the Nipkow disk. The Nipkow disk scans in lateral direction to get a two dimensional image at high speed while being rotated.

The objective lens element in the confocal system with vari-focus optical element determines system depth of focus and the distance between object and image plane of the detector.

The objective lens element in the confocal system with vari-focus optical element further comprises tube lens wherein the objective lens element and the tube lens make conjugation of the system between object and image plane of detector.

The confocal system with vari-focus optical element can further comprise a light division element wherein the light division element splits the light from the illumination source and redirect light to use axis symmetric the vari-focus optical element. For the reflective type of the vari-focus optical element, these light division element is a must to conserve axis symmetry in the optical system

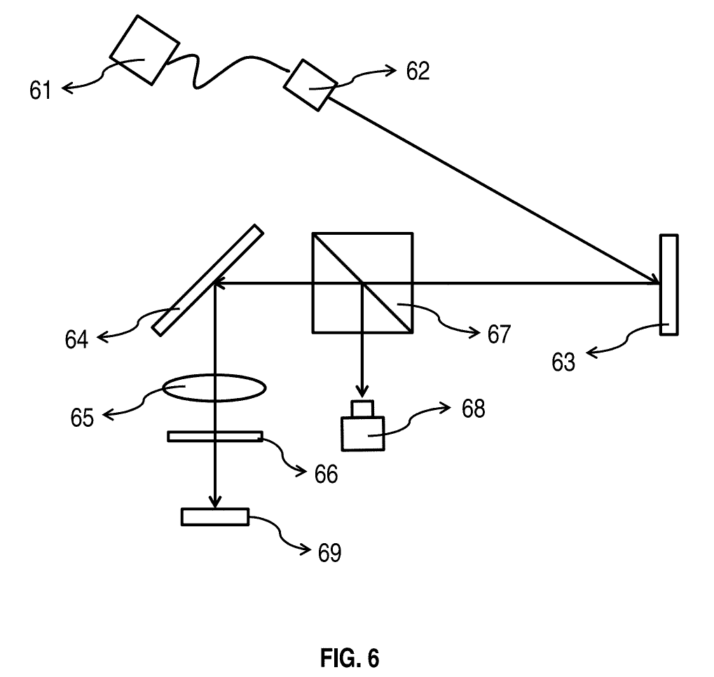

FIG. 6 shows another configuration of the present invention, the confocal microscopy system with vari-focus optical element. In this configuration, non-axis symmetric vari-focus optical element 64 is used. Other configuration is similar with that of FIG. 5 axis symmetric configuration. Light beam is launched from the illumination source 61 and optionally the light beam is optionally collimated by the collimating element 62. The collimating element produces suitable optical beam size, divergence for the confocal microscopy system. In the example, DMD (Digital Micromirror Device) is used as an aperture array element 63. In this specific example, aperture array is generated by turning on/off each pixel in SLM (spatial light modulator). DMD device is a good example of SLM with reflective geometry.

Reflected beam from the aperture array element 63 is now multiple illumination apertures for corresponding pixels in the confocal microscopy image. Beam splitter 67 is used for redirecting the beam of the confocal microscopy system. The light beam is firstly reflected by the vari-focus optical element 64. The vari-focus optical element 64 is non-axis symmetric optical element. In this figure, the vari-focus element is using reflective geometry rather than transmission one. Then reflected light beam in which the focal plane of the confocal image was changed by the vari-focus element passes through objective lens 65. The objective lens 65 makes an image from the object sample 69 onto the photosensitive optical sensor device 68. Also, optical retarder 66 can be used so that the optical retarder changes polarization status of the illumination beam and imaging beam thus when polarization beam splitter can be used, light loss can be minimized through polarization control.

While the aperture array element 63 is making aperture arrayed beam, there should be enough separation for avoiding confocal image interference between confocal points. These apertures in the aperture array element 63 moves with time to scan object sample 69 laterally. The apertures are moving together to cover all the field of view of the object. When the lateral scanning is done, a two dimensional image can be obtained. This image should be obtained through software algorithm with filtering clear image pixels from the taken confocal images. Each pixel is selected from the group of the images taken by the confocal microscopy system. In other words, the image pixels from the sensor with sharing confocal property can only be taken. Thus image quality of the confocal microscopy system can be enhanced beyond the diffraction limit of the optical system by constraining the pixel by the confocal apertures.

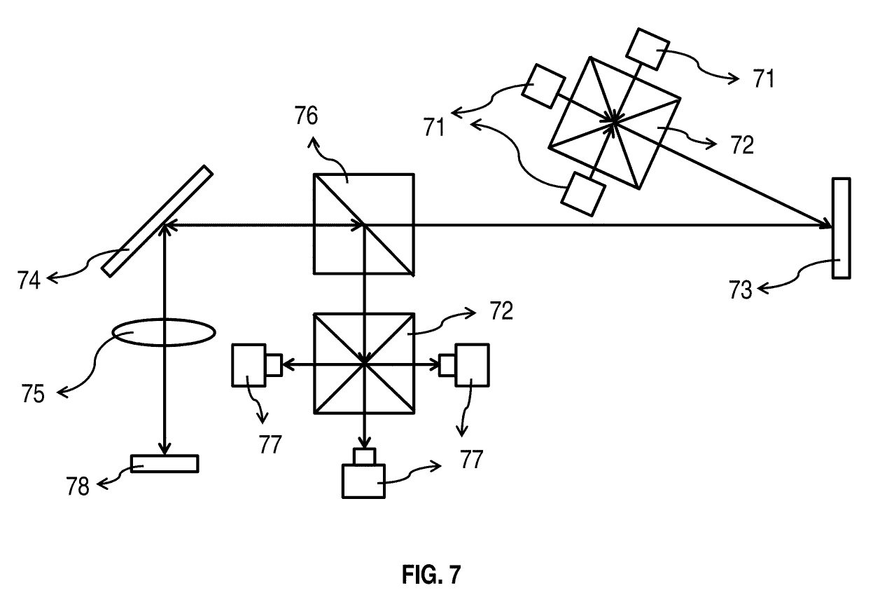

In FIG. 7, third configuration of the present invention, confocal microscopy with vari-focus optical element is illustrated. This configuration is similar with first and second configurations in FIG. 5 and FIG. 6 except that multiple illumination sources are used or multiple colored filtered image sensors are used. The individual multiple illumination sources 71 were launched. These should have multiple wavelength illumination sources. For example, RGB (Red, Green, and Blue) light sources can be used. If multiple colored light beams are used, the image taken by the confocal microscopy can accommodate wavelength dependent response, thus it can make color dependent images of the object sample 78. The individual multiple illumination sources 71 are combined through cross dichroic prism (X-cube) 72. Other kind of dichroic configuration can be adapted here for combining multiple colored beams. And the combined beam is optionally collimated by the collimating element. The collimating element produces suitable optical beam size, divergence for the confocal microscopy system. In this example, DMD (Digital Micromirror Device) is used as an aperture array element 73. In this specific example, aperture array is generated by turning on/off each pixel in SLM (spatial light modulator). DMD device is a good example of SLM.

Reflected beam from the aperture array element 73 is now multiple illumination sources for corresponding pixels in the confocal microscopy image. Beam splitter 76 is used for capturing reflected beam from the object sample 78. The light beam is firstly reflected by the vari-focus optical element 74. The vari-focus optical element 74 is non axis-symmetric optical element. In this figure, the vari-focus element is using reflective geometry rather than transmission one. Then reflected light in which the focal plane of the confocal image was changed by the vari-focus element passes through objective lens 75. The objective lens 75 makes an image from the object sample 78 onto the photosensitive optical sensor devices 77. Also, in the image plane side, by using dichroic filter configuration (for example, cross dichroic prism 72) can be used for imaging each colored image. The color control can be obtained through rotating color wheel or PWM (Pulse Width Modulation) method to detect each color (or wavelength beam) through cross dichroic prism 72. While taking color images, vari-focus optical element 74 can be operated based on the each color wavelength to minimize color aberration of the whole confocal microscopy system.

While the aperture array element 73 is making aperture arrayed beam, there should be enough separation for avoiding confocal image interference between confocal points. These apertures in the aperture array element 73 moves with time to scan object sample 78 laterally. The apertures are moving together to cover all the field of view of the object. When the lateral scanning is done, a two dimensional image can be obtained. This image should be obtained through software algorithm with filtering clear image pixels from the taken confocal images. Each pixel is selected from the group of the images taken by the confocal microscopy system. In other words, the image pixels from the sensor with sharing confocal property can only be used to improve resolution of the system. Thus image quality of the confocal microscopy system can be enhanced beyond the diffraction limit of the optical system.

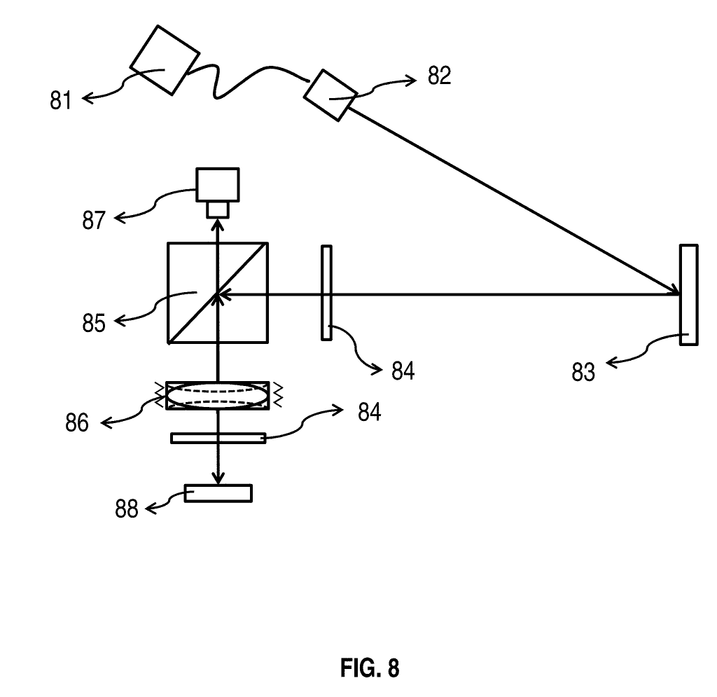

FIG. 8 is a layout with the vari-focus optical element 86 with transmission geometry. Liquid lens or piezo-motor driven lens module or VCM (Voice Coil Motor) driven optical element 86 can be used as a transmission vari-focus optical element. For example, liquid lens optical element is using surface tension of a liquid by changing the electric field for forming optical surface of the lens. The curvature of the lens changes by the electric filed. And other kinds like piezo-driven or VCM driven lens module use lens movement rather than changing lens surface itself. The light launched from the illumination source 81 is optionally collimated by the collimating element 82. Then the collimated light hits the aperture array element 83. In this specific example, the beam is reflected by the aperture array element 83 and forms beam with multiple apertures. Reflected beam from the aperture array element 83 is now multiple light sources for corresponding apertures in the confocal microscopy image. In this specific example, aperture array is generated by turning on/off each pixel in SLM (spatial light modulator). DMD device is a good example of SLM. Optical retarders 84 can be used optionally to enhance light efficiency of the system in the configuration of PBS (Polarization Beam Splitter) 85. Both optical retarders are used for controlling polarization of the optical beam and enhance the optical efficiency based on PBS 85 geometry of the system. PBS 85 are used for redirecting the beam of the confocal microscopy system. The light beam is firstly reflected by transmission vari-focus optical element 86. Transmission vari-focus optical element 86 makes an image from the object sample 88 onto the photosensitive optical sensor device 87 through electronic signal. Three dimensional images can be obtained by scanning focal plane of the system by changing optical property of the transmission vari-focus optical element or position of optical element by the piezo driven or VCM driven optical lens module.

While the aperture array element 83 is making aperture arrayed beam, there should be enough separation for avoiding confocal image interference between confocal points. These apertures in the aperture array element 83 moves with time to scan object sample 88 laterally. The apertures are moving together to cover all the field of view of the object. When the lateral scanning is done, a two dimensional image can be obtained. This image should be obtained through software algorithm with filtering clear image pixels from the taken confocal images. Each pixel is selected from the group of the images taken by the confocal microscopy system. In other words, the image pixels from the sensor with sharing confocal property can only be used to improve resolution of the system. Thus image quality of the confocal microscopy system can be enhanced beyond the diffraction limit of the optical system.

As described in FIG. 5, Nipkow disk or other aperture array devices can be used in the configuration in FIG. 6, FIG. 7 and FIG. 8. And the axis symmetric configuration in FIG. 5 and non-axis symmetric configuration in FIG. 6 and FIG. 7 can be chosen based on requirements and geometry of the system. The illumination source can be selected from laser, individual colored LED (light emitting diode), white light lamps or LED, and so on.

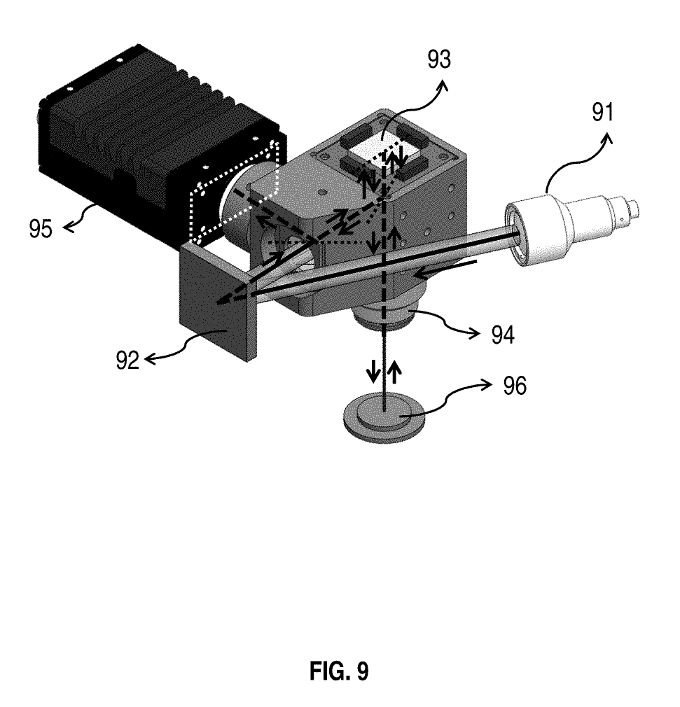

In FIG. 9, real three dimensional mechanical model for confocal microscopy system is given. Light collimating element 91 is given in the figure. This collimating element can accept light beam from the illumination source through optical fiber delivery (not shown in the figure). One side has fiber coupler from the illumination source and the other side has collimating lens with telescope to manipulate illumination source to have proper beam parameters for the confocal microscopy system. The collimated beam can be further manipulated through the aperture array element 92. In this specific configuration, DMD device is used to make aperture array for the confocal system. The aperture arrayed beam is passing through the two PBS's and reflected to the vari-focus optical element 93. The vari-focus optical element changes beam focusing parameter of the objective lens 94. In this example, a Micromirror Array Lens is used for the vari-focus optical element. Then the light after the objective lens 94 is focused onto the object sample 96 and reflected back through the objective lens 94.

The imaged beam is again passes through the vari-focus optical element 93, wherein the vari-focus optical element 93 maintaining confocal property of the system. After the vari-focus optical element 93, the light is imaged onto the photosensitive optical sensor device 95. With this configuration, lateral scanning of the sample is obtained by the aperture array element 92 and the axial scan (depth wise scan) is obtained through the vari-focus optical element. Since the aperture array element can be operated at high speed and the vari-focus optical element is also operating at very high speed. Three dimensional imaging can be achieved by the aperture array element and the vari-focus optical element. Thanks to the speed of the two elements, fast scanning of three dimensional imaging can be obtained.

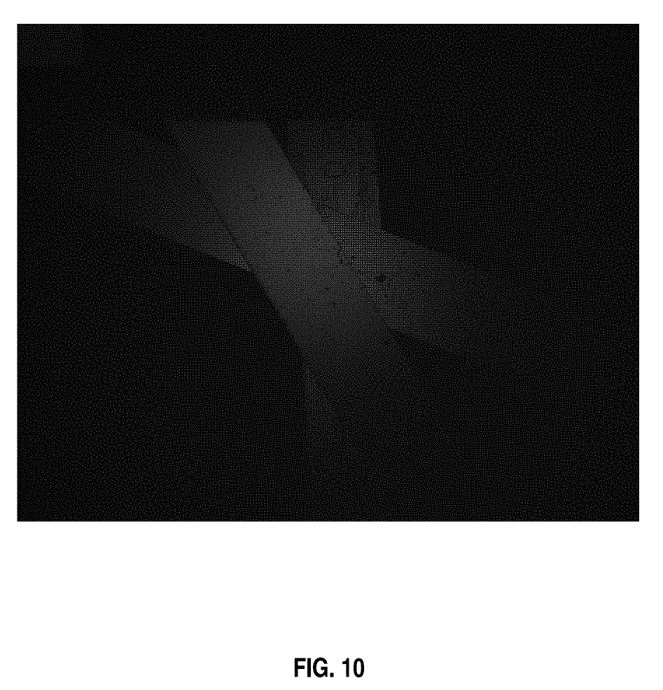

In FIG. 10, one step image of the present invention configuration. This image was taken with a configuration of aperture array. The aperture array was hold while the image was taken. The image was taken with rectangular array of apertures. And the apertures are scanned through the operation of the DMD device. Whole area of the spatial light modulator was used for taking two dimensional image of the confocal microscopy system. Since the image was taken through rectangularly located apertures, the image taken gives periodic points in rectangular shape if the image was investigated carefully.

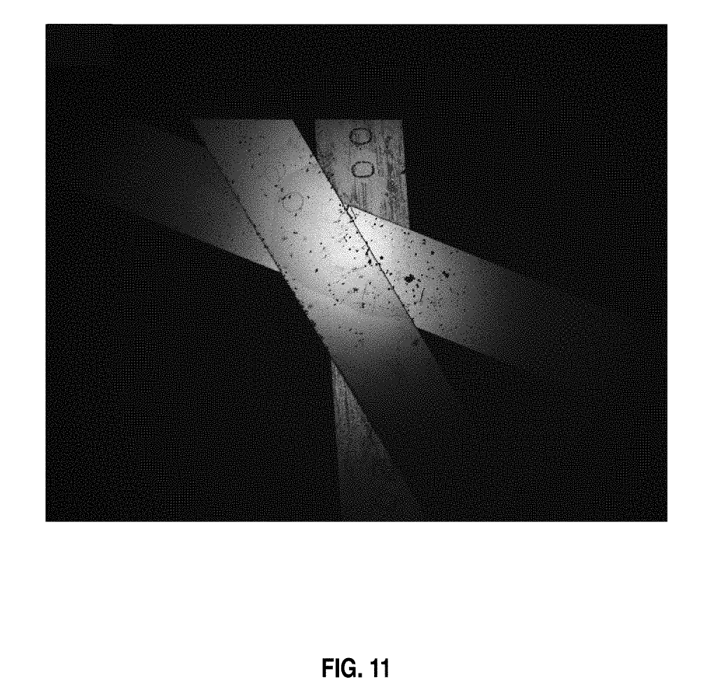

In FIG. 11, two dimensional image was taken with configuration in FIG. 9. Lateral scan was achieved through DMD device and from the individual images taken with scan, two dimensional image of the sample was reconstructed by image processing. To get this two dimensional image, array apertures are scanned to cover all the object plane areas.

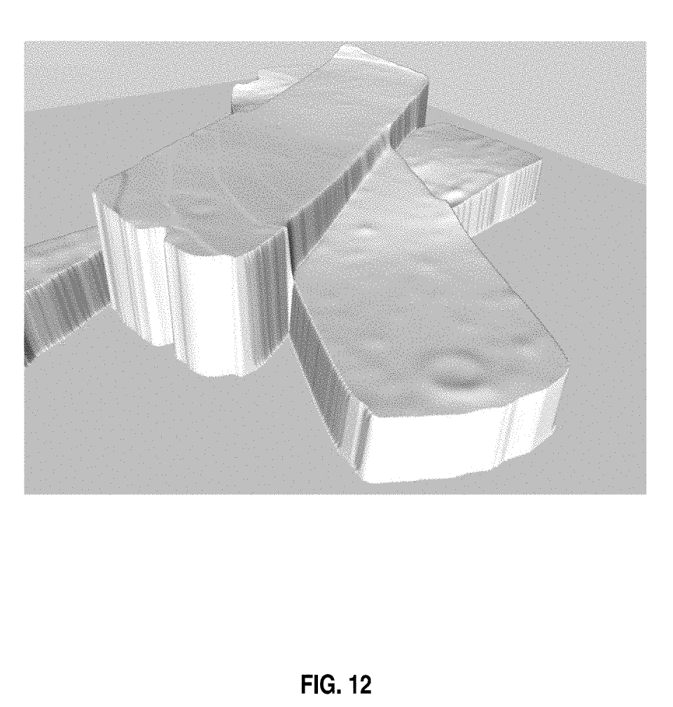

In FIG. 12, reconstructed three dimensional image is given. Multiple images can be taken by scanning the vari-focus optical element, wherein the focal plane of the objective lens is scanned based on the focus change of the vari-focus optical element. After taken multiple two dimensional images in FIG. 11 while changing focal planes, image processing reconstruction is performed. Only in-focused pixels are taken and displayed then all-in-focus image can be obtained (not shown in the figure). And if this all-in-focused image is reconstructed with depth information (which can be obtained through the repeatable vari-focus optical element), three dimensional image can be obtained. Thus with lateral scanning of the aperture array element, two dimensional images are obtained and with axial scanning of the vari-focus optical element, each pixel in two dimensional image of all-in-focused image can have depth wise information. The all-in-focused image with depth information can make three dimensional image of the object sample through the confocal microscopy system with vari-focus optical element. Unfortunately, the image beneath the object cannot be obtained. Thus the image has somewhat like fused structure in three dimensional shape.

The Micromirror Array Lens and its controlling optical surface profile with the general principle, structure and methods for making the micromirror array devices and Micromirror Array Lens are disclosed in U.S. Pat. No. 7,330,297 issued Feb. 12, 2008 to Noh, U.S. Pat. No. 7,365,899 issued Apr. 29, 2008 to Gim, U.S. Pat. No. 7,382,516 issued Jun. 3, 2008 to Seo, U.S. Pat. No. 7,400,437 issued Jul. 15, 2008 to Cho, U.S. Pat. No. 7,411,718 issued Aug. 12, 2008 to Cho, U.S. Pat. No. 7,474,454 issued Jan. 6, 2009 to Seo, U.S. Pat. No. 7,488,082 issued Feb. 10, 2009 to Kim, U.S. Pat. No. 7,535,618 issued May 19, 2009 to Kim, U.S. Pat. No. 7,589,884 issued Sep. 15, 2009 to Sohn, U.S. Pat. No. 7,589,885 issued Sep. 15, 2009 to Sohn, U.S. Pat. No. 7,605,964 issued Oct. 20, 2009 to Gim and U.S. Pat. No. 7,898,144 issued Mar. 1, 2011 to Seo, all of which are incorporated herein by references.

Also the applications for Micromirror Array Lens and Hybrid Micromirror Array Lens are disclosed in U.S. Pat. No. 7,068,416 issued Jun. 27, 2006 to Gim, U.S. Pat. No. 7,077,523 issued Jul. 18, 2006 to Seo, U.S. Pat. No. 7,261,417 issued Aug. 28, 2007 to Cho, U.S. Pat. No. 7,315,503 issued Jan. 1, 2008 to Cho, U.S. Pat. No. 7,333,260 issued Feb. 19, 2008 to Cho, U.S. Pat. No. 7,350,922 issued Apr. 1, 2008 to Seo, U.S. Pat. No. 7,768,571 issued Aug. 3, 2010 to Kim, U.S. Pat. No. 8,049,776 issued Nov. 1, 2011 to Cho, U.S. patent application Ser. No. 11/076,688 filed Mar. 10, 2005, U.S. patent application Ser. No. 11/208,114 filed Aug. 19, 2005, U.S. patent application Ser. No. 11/208,115 filed Aug. 19, 2005, U.S. patent application Ser. No. 11/382,707 filed May 11, 2006, all of which are incorporated herein by references.

While the invention has been shown and described with reference to different embodiments thereof, it will be appreciated by those skills in the art that variations in form, detail, compositions and operation may be made without departing from the spirit and scope of the invention as defined by the accompanying claims.

What is claimed is:

1. A confocal system with vari-focus optical element comprising:
a. an illumination source;
b. an aperture array element;
c. a vari-focus optical element wherein the vari-focus optical element changes focal plane of the system;
d. an objective lens element; and
e. a photosensitive optical sensor device;
wherein said aperture array element and the vari-focus optical element scans laterally and axially to get three dimensional images.

2. The confocal system with vari-focus optical element in claim 1, wherein the vari-focus optical element is a Micromirror Array Lens.

3. The confocal system with vari-focus optical element in claim 2, wherein the Micromirror Array Lens comprises of multiple micromirrors wherein the micromirrors reflects light so that the Micromirror Array Lens makes lens surface.

4. The confocal system with vari-focus optical element in claim 2, wherein the micromirrors in the Micromirror Array Lens have individual rotation and translation satisfying convergence condition of the system.

5. The confocal system with vari-focus optical element in claim 2, wherein the Micromirror Array Lens changes focal plane of the system with each micromirror angle in the Micromirror Array Lens while satisfying phase matching condition.

6. The confocal system with vari-focus optical element in claim 1, wherein the illumination source is collimated by an optical lens or lenses.

7. The confocal system with vari-focus optical element in claim 1, wherein the aperture array element comprises a pixel switching element.

8. The confocal system with vari-focus optical element in claim 7, wherein the pixel switching element makes optical aperture or optical apertures by the electric property of the pixel switching element with individual pixel controlling.

9. The confocal system with vari-focus optical element in claim 7, wherein the pixel switching element further comprises an actuator wherein the actuator makes the pixel switching element laterally.

10. The confocal system with vari-focus optical element in claim 1, wherein the aperture array comprises a Nipkow disk wherein the Nipkow disk comprise pattern of circular path traced small pinholes.

11. The confocal system with vari-focus optical element in claim 1, wherein the objective lens element determines system depth of focus and the distance between object and image plane of the detector.

12. The confocal system with vari-focus optical element in claim 11, wherein the objective lens element further comprises tube lens wherein the objective lens element and the tube lens make conjugation of the system between object and the image plane of the detector.

13. The confocal system with vari-focus optical element in claim 1, further comprising a light division element wherein the light division element splits the light from the illumination source and redirect light to maintain axis-symmetric configuration of the vari-focus optical element.

14. A confocal system with vari-focus optical element comprising:
a. an illumination source;
b. an aperture array element;
c. a vari-focus optical element wherein the vari-focus optical element is transmission optical element and changes focal plane of the system; and
d. a photosensitive optical sensor device;
wherein the aperture array element and the vari-focus optical element scans laterally and axially to get three dimensional images.

15. The confocal system with vari-focus optical element in claim 14, wherein the vari-focus optical element is an electric field driven liquid lens.

16. The confocal system with vari-focus optical element in claim 14 wherein the vari-focus element is a piezo driven lens by varying position of optical element.

17. The confocal system with vari-focus optical element in claim 14, wherein the vari-focus optical element determines system depth of focus and the distance between object and image plane of the detector.

18. The confocal system with vari-focus optical element in claim 14, wherein the illumination source is collimated by an optical lens or lenses.

19. The confocal system with vari-focus optical element in claim 14, wherein the aperture array element comprises a pixel switching element.

20. The confocal system with vari-focus optical element in claim 19, wherein the pixel switching element makes optical aperture or optical apertures by the electric property of the pixel switching element with individual pixel controlling.

21. The confocal system with vari-focus optical element in claim 19, wherein the pixel switching element further comprises an actuator wherein the actuator makes the pixel switching element laterally.

22. The confocal system with vari-focus optical element in claim 14 wherein the aperture array comprises a Nipkow disk wherein the Nipkow disk comprise pattern of circular path traced small pinholes.
